(19) United States
(12) Patent Application Publication
(10) Pub. No.: US 2023/0406731 A1
(43) Pub. Date: Dec. 21, 2023

(54) METHOD AND APPARATUS FOR ELECTRO-CHEMICAL TREATMENT OF CONTAMINATED WATER

(71) Applicant: Mainfraim Industries LLC, Corrales, NM (US)

(72) Inventors: Michael L. Fraim, Tijeras, NM (US); Jean-Marc D. Grindatto, Corrales, NM (US)

(73) Assignee: Mainfraim Industries LLC, Corrales, NM (US)

(21) Appl. No.: 18/212,125

(22) Filed: Jun. 20, 2023

Related U.S. Application Data
(60) Provisional application No. 63/353,779, filed on Jun. 20, 2022.

(51) Int. Cl. C02F 1/461; C02F 1/36; C02F 1/467

(52) U.S. Cl. CPC C02F 1/46104; C02F 1/36; C02F 1/4672; C02F 2001/46119; C02F 2101/101

(57) ABSTRACT

A method and apparatus that can include an electrolytic cell and reactor chamber with an upstream ultrasonic cleaning system of the cell for the treatment contaminated water, which can include industrial wastewater containing high concentrations of inorganic compounds and elements. The contaminated water can optionally be effluent from open pit ponds and subterranean mining, produced water from oil and gas activities (upstream, midstream and downstream), ash ponds from the utilities industry, red mud ponds from aluminum production among many industries that produce industrial wastewater with heavy inorganic material concentration.

### CROSS-REFERENCE TO RELATED APPLICATIONS

This application claims priority to and the benefit of the filing of U.S. Provisional Patent Application No. 63,353,779, entitled “Apparatus and Method for the Electro-Chemical Treatment of High-Volume Wastewater Streams with High-Load Contamination of Inorganic Compounds and Elements”, filed on Jun. 20, 2023, and the specification and proposed claims thereof are incorporated herein by reference.

### BACKGROUND OF THE INVENTION

Embodiments of the present invention relate to improvements in electrolytic cell and reactor chambers to enable the removal and/or capture of inorganic compounds and elements from contaminated water, which can include but is not limited to industrial wastewater. Such industrial wastewater can include but is not limited to industrial wastewater produced in the mining, oil and gas, utilities, and/or various manufacturing industries.

There is a present need for improvements in electrolytic cell and reactor chamber configuration to enable the efficient process of inorganic compound and element removal and/or capture from contaminated water, including various industrial wastewater streams, and to enable high-flow, high-volume, high-loading contaminated wastewater to be treated in real-time with close to 100% precipitation of targeted inorganic contamination.

For the most part, current electrolytic cell design adequately removes organic compounds and elements from contaminated water with electrolytic chlorination. However, current electrolytic cells are especially inadequate in addressing inorganic compounds and elements mixed in highly contaminated wastewater streams.

Industrial wastewater is generally disposed of underground by injection (oil and gas industry practices) or left untreated in lined or unlined ponds (mining, utilities, manufacturing practices) to reduce the possibility of leaching of the toxic inorganic elements into the ground and groundwater— including for example heavy metals including lithium, selenium, strontium, vanadium, rare earth elements (“REE”) including neodymium, cerium, scandium, and compounds that can include metal sulfides. Over the long-term, inorganic compounds and elements eventually leach into the ground and groundwater—the wastewater pond containment method is never a permanent solution.

One shortcoming of the electrolytic cells of the type illustrated as reference numbers 91, 92, and 93, as illustrated in FIG. 1 of a known device, is the uneven distribution of electric current in the cell, which causes coating corrosion and eventually ruins the electrodes. Progressive corrosion also reduces the efficiency to produce enough oxidants and diminish the ability for close to 100% precipitation of metals and rare earth elements from wastewater.

Another shortcoming of such an electrolytic cell is the inability to completely remove the scale build-up on the coating caused by highly contaminated wastewater with inorganic compounds and elements. As a result, the scale build-up and resulting corrosion of the cell occurs at a much higher rate than treating less contaminated wastewater, regardless of the cleaning method used to eliminate the scale build-up.

The usual method used to clean the cell from corrosion is reversing the polarity of the anode and cathode pairs. This cleaning method is insufficient in high-scale wastewater with high loading of inorganic contamination unless daily servicing and maintenance is performed on the cell.

Another shortcoming of such known reactor chambers containing the electrolytic cell is the material and design that allows gases—including for example, hydrogen sulfide (“H₂S”) found in wastewater streams to corrode piping, connections, chambers, and other parts, and quickly render the power and computer equipment inoperable.

The root causes for these shortcomings are found in the design assembly of the electrolytic cell and its placement and configuration within the reactor chamber, specifically the top-down power connections of the anodes and cathodes, which result in uneven current distribution, and the physical connection to the ultrasonic sources which result in lack of sound coverage of the cell and thus missing areas of scale build-up and thereby causing corrosion.

There is thus a present need for a method and apparatus that provides a different configuration in the assembly of the electrolytic cell and the reactor chamber containing the cell, as well as the method of operation, which improves on the materials used to operate in a high-volume, high-contaminant, high-acidic applications for industrial wastewater treatment.

### BRIEF SUMMARY OF EMBODIMENTS OF THE PRESENT INVENTION

Embodiments of the present invention relate to an electro-chemical reaction cell having at least one anode electrode, at least one cathode electrode, at least one ultrasonic transducer, the at least one ultrasonic transducer disposed in a location such that it is not directly coupled to the at least one anode electrode and not directly coupled to the at least one cathode electrode, the at least one ultrasonic transducer disposed such that when fluid is disposed within or otherwise passes through the electro-chemical reaction cell, mechanical conduction of ultrasonic waves is provided to the at least one anode electrode and to the at least one cathode electrode via the fluid. In one embodiment, the fluid can be a liquid and can optionally include wastewater. The at least one ultrasonic transducer can be disposed upstream of the at least one anode electrode and of the at least one cathode electrode. The at least one ultrasonic transducer can include at least two ultrasonic transducers. The at least one anode electrode can include at least one anode electrode plate and the at least one cathode electrode can include at least one cathode electrode plate. The at least one cathode plate can be attached to a cathode electrode rod by sandwiching it between a pair of threaded nuts with or without intervening washers. The at least one anode plate can be attached to an anode electrode rod by sandwiching it between a pair of threaded nuts with or without intervening washers.

In one embodiment, the at least one anode plate can be electrically isolated from a cathode electrode rod which passes through the at least one anode plate. The at least one cathode plate can be electrically isolated from a cathode electrode rod which passes through the at least one anode plate. Optionally, at least one cell spacer can be disposed on at least one of the at least one cathode electrode and/or disposed on at least one of the at least one anode electrode. In one embodiment, the at least one cell spacer can be a plurality of cell spacers and the plurality of cell spacers can be positioned such that bubbles within the fluid are directed to the sides of the at least one cathode electrode and/or to the sides of the at least one anode electrode.

Embodiments of the present invention also relate to a method for providing an electro-chemical reaction that includes passing a flow of current from at least one anode electrode, through a fluid to be treated, to at least one cathode electrode, applying ultrasonic vibrations to at least one of the at least one anode electrode and/or the at least one cathode electrode by conducting the ultrasonic vibrations through the fluid to be treated, without directly coupling an ultrasonic transducer to the at least one anode electrode or the at least one cathode electrode. The method can also include passing the fluid by an ultrasonic transducer before the fluid passes the at least one anode electrode and before the fluid passes the at least one cathode electrode. The method can also include forming nano crystals in the fluid with the ultrasonic vibrations that are conducted through the fluid.

In one embodiment, the method can also include at least partially cleaning at least one of the at least one anode electrode and/or the at least one cathode electrode with the applied ultrasonic vibrations. Optionally, applying ultrasonic vibrations can include applying ultrasonic vibrations which are tuned to a resonant frequency of at least one of the at least one anode electrode and or of the at least one cathode electrode. Applying ultrasonic vibrations can include applying ultrasonic vibrations which include a frequency of between about 8 kilohertz to about 45 kilohertz. Optionally, applying ultrasonic vibrations can include applying ultrasonic vibrations at a first power level for nano seed crystal generation and at a second power level for electrode cleaning. The first power level can include a power level of about 0.01 watts per cubic centimeter per minute of fluid flow to a power level of about 0.1 watts per cubic centimeter per minute of fluid flow. The second power level can include a power level of about 1 watt per cubic centimeter per minute of fluid flow to a power level of about 40 watts per cubic centimeter per minute of fluid flow. The method can also include directing bubbles away from at least one of the at least one anode electrode and/or the at least one cathode electrode with one or more cell spacers.

Embodiments of the present invention relate to treating contaminated water, which can include industrial wastewater streams, with high loads of inorganic contaminants such that the inorganic compounds and elements can be removed or captured from the wastewater streams. Embodiments of the present invention can precipitate inorganic compounds and elements at about 91.0% at a flow rate of 150 cubic centimeters per minute per square centimeter of plate surface area to about 99.5% of stoichiometric composition at flow rate of 1.50 cubic centimeters per minute per square centimeter of plate surface area.

In one embodiment, the inside part of the apparatus, specifically the electrolytic cell, preferably includes a bolted arrangement of anodes, cathodes, and bipolar plates, wherein the bolt and spacers most preferably connect around the geometric center of each anode, cathode, and bipolar plate. The plates can also be fastened by welding the parts or via another type of mechanical fastener. In one embodiment, the plates are preferably generally rectangular but can also include round or other shapes—most preferably shapes having a geometric center or the balancing point at the hole location. This arrangement distributes the current through the anode and cathode plates evenly to maximize the current flowing through the wastewater medium.

Optionally, plates can be disposed between active anode and cathode plates to function as bipolar plates to allow for even more uniform current distribution through the medium and the active surfaces of the cell. As used herein, the term “bipolar plate(s)” includes an electrically conductive plate that is not directly electrically coupled to the anode or cathode, except perhaps through any current flowing though the wastewater that is being treated. In one embodiment, the bipolar plate is preferably thermally and electrically conductive and can optionally be formed from a metallic material.

The cell can contain from a minimum of about 2 to about 21 or more anode, cathode, (and optionally bipolar plates) separated by insulating spacers. The anode, cathode, and bipolar plates are preferably formed or otherwise cut and finished in such a manner as to further reduce the possibility of scale build-up that initiates corrosion of the plates. Such finishing can include for example wet and/or dry polishing, sandblasting, glass or bead blasting, and/or mechanical machining of sharp edges.

The spacing between the anode and cathode plates can optionally be determined by the plate voltage (plate resistance multiplied by amperage) to treat the wastewater while allowing for larger particles to pass through without impeding the electrolytic reaction. The outermost anode and cathode plates are preferably placed as close to the reactor chamber walls as possible to treat the maximum volume of wastewater at high flow and for 100% (or about 100%) of the water to flow between anode and cathode plates.

In one embodiment, the cell assembly anodes and cathodes are preferably coated separately in their entirety so they each function as one single anode and cathode unit resonant piece, like a tuning fork, for the ultrasonic system to loosen the scale built-up over time. Both anode and cathode units are preferably interlocked for final assembly after coating. Coatings can be made of iridium oxide, ruthenium oxide, hafnium oxide, graphene oxide, or made of ceramic alloys including but not limited to boron-doped or nitrogen-doped diamond.

The reactor chamber preferably contains the cell and immersible ultrasonic transducers in a specific arrangement. The ultrasonic transducers are preferably located upstream from the cell. In one embodiment, the ultrasonic transducers are not physically connected to the anode or cathode plates. Instead, wastewater is the medium that propagates sound to initiate vibration of the cell. The cell preferably resonates like a tuning fork without the ultrasound transducers being directly attached to the cell. Although the figures illustrate ultrasonic transducers placed in a particular upstream location and configuration within the reactor chamber, this is merely done for illustrative purposes as the placement of the ultrasonic transducers can be changed will still providing desirable results—especially if the transducers are upstream from the cell.

In one embodiment, the flow of wastewater preferably enters the chamber on the bottom and exits on the top, so that gravity segregation separates the gas bubbles forming as part of the electrolytic reaction to improve performance of the sound propagating through the water phase to reach the electrode plates. The gas bubbles are preferably collected downstream of the cell wall out of the way of the propagating ultrasound wave before the wave contacts and vibrates the electrode plates.

The power, computing, and ultrasonic equipment to control amperage and sound preferably reside in a dry area to isolate them from any acid-caused corrosion, wetness, or other processes that negatively affect the power equipment. The entire apparatus can be installed in-situ, preferably inside a stationary building or mobile container or trailer, which can include for example a shipping container, to move the apparatus from project to project.

The flow volumes deemed “high-flow,” or “high-rate” applications preferably exceeds about 2,500 barrels per day per reactor chamber, or about 95 gallons per minute per reactor chamber at the minimum for highly contaminated wastewater. For lightly contaminated wastewater, “high-flow” or “high-rate” can exceed about 5,000 barrels per day per reactor chamber, or about 190 gallons per minute per reactor chamber.

In one embodiment, the targeted normalized flow rate is about 1.5 to about 150 cubic centimeters per minute per square centimeter of plate surface area, depending on the level of contamination to be treated.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a drawing which illustrates a known electrolytic cell of the prior art;

FIGS. 2A and 2B are drawings which respectively illustrate a front and side view of a monopolar plate having a square shape;

FIGS. 2C and 2D are drawings which respectively illustrate a front and side view of a monopolar plate having a rectangular shape;

FIGS. 2E and 2F are drawings which respectively illustrate a front and side view of a monopolar plate having a round shape;

FIGS. 3A, 3B, and 3C are drawings which illustrate anode current profiles for a square plate (FIG. 3A), a rectangular plate (FIG. 3B), and a round plate (FIG. 3C)— the figures illustrate even decay of current as it leaves the anode to follow the surface of the plates;

FIG. 4 is a drawing which illustrates a front view of a plate assembly with a bipolar plate disposed to increase the voltage to treat the fluid;

FIG. 5 is a drawing which illustrates a side view of a plate assembly and which illustrates voltage polarity of the assembled parts;

FIG. 6 is a drawing which illustrates various components used to form a plate assembly connected to electrodes, according to an embodiment of the present invention, which includes bolts, nuts, washers, and insulating spacers;

FIG. 7 is a drawing which illustrates plates having a curved (i.e. “radiused”) edge, and which includes a dimensionally stable coating;

FIGS. 8A and 8B are drawings which respectively illustrate front and side views of a plate having baffles that provide flow deflection, which baffles are positioned in a slanted orientation with respect to the direction of the flow;

FIGS. 8C and 8D are drawings which respectively illustrate front and side views of plates having baffles that provide flow deflection, which baffles are positioned in a perpendicular orientation with respect to the direction of the flow;

FIG. 9 is a drawing which illustrates a flow of bubbles through baffles;

FIGS. 10A and 10B are drawings which respectively illustrate a reactor chamber having a housing that is transparent to illustrate the configuration of the cell assembly in a perspective view (FIG. 10A) and in a side view (FIG. 10B) and which is configured such that flow through the reactor enters at the bottom and exits the top of the chamber;

FIGS. 11A, 11B, and 110 are drawings which respectively illustrate alternative placements of ultrasound transducers;

FIG. 12 is a drawing which illustrates an electro-chemical treatment system according to an embodiment of the present invention;

FIG. 13 is a drawing which illustrates the injection of pre-cursors into the flow at a location prior to electro-chemical treatment;

FIG. 14 is a drawing which illustrates an embodiment of the present invention that includes a metal capture apparatus;

FIG. 15A is a drawing which illustrates a possible cell configuration for a monopolar system is a drawing which illustrates possible cell configuration of a chamber for monopolar operation according to an embodiment of the present invention;

FIG. 15B is a drawing which illustrates a front view of a metallic return bar which can be used in an embodiment of the present invention; and

FIGS. 15C and 15D are drawings which respectively illustrate a front view and a side view of an anode plate according to an embodiment of the present invention.

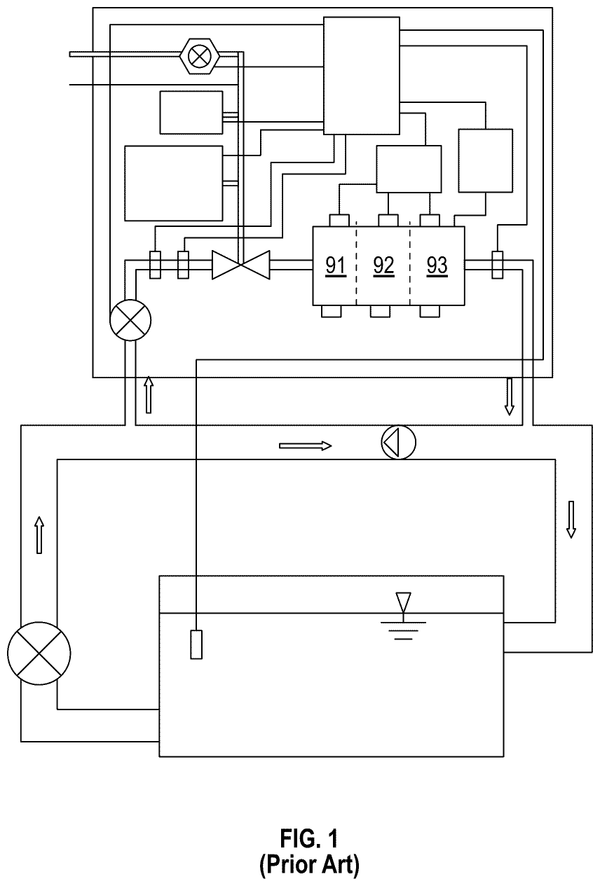

### DETAILED DESCRIPTION OF THE INVENTION

Embodiments of the present invention relate to treating wastewater, which can include industrial wastewater streams, which wastewater can contain high loads of inorganic contaminants, such that the inorganic compounds and elements can be removed and/or captured from the wastewater streams. Occasionally, the term “monopolar” is used to describe a configuration wherein no bipolar plates are provided, thus each plate has only a positive or negative charge applied to it. Thus, monopolar plates can comprise an anode and/or a cathode plate but not a bipolar plate.

An embodiment of the present invention provides the ability to precipitate the inorganic salts at the cathode or anode. In addition, one or more precursors, which can include for example sodium carbonate and/or carbon dioxide, can be added to cause an inorganic carbonate salt to precipitate on the cathode surface. Another example is the addition of sulfur dioxide or sodium sulfate for precipitation of an inorganic sulfate salt on the anode surface.

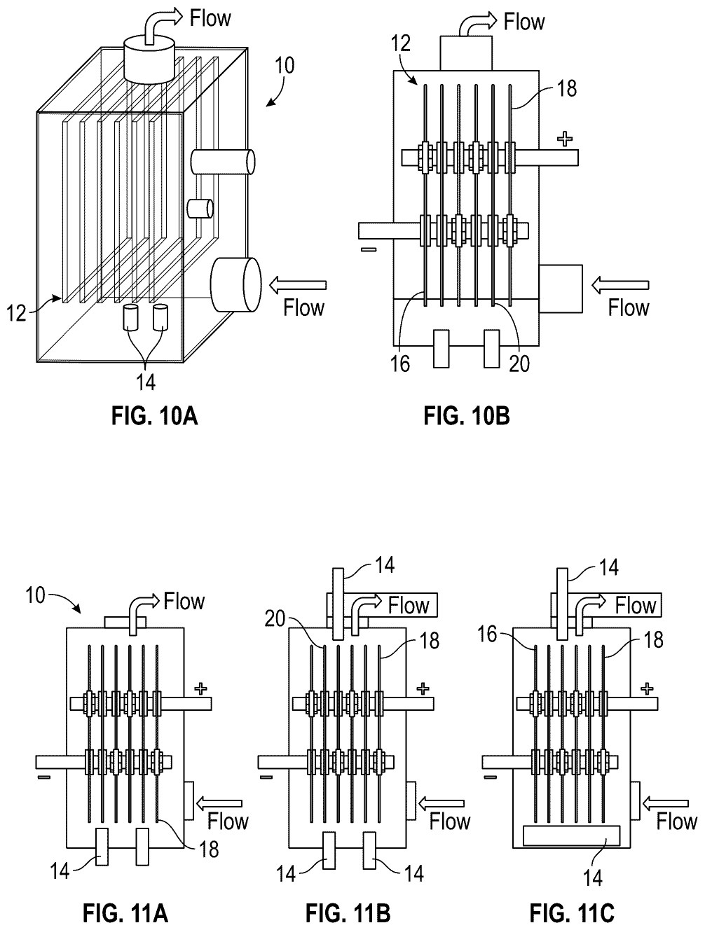

In one embodiment, the pretreatment of fluid with ultrasound is used to create small seed crystals, which can include for example nano seed crystals, for precipitation on either cathode or anode surfaces as illustrated in FIGS. 10A and 10B. This portion reduces supersaturation in the Faraday zone (boundary layer) between the bulk fluid and the solid precipitant on the electrode surfaces. It helps to approach the stoichiometric ratio for precipitation of inorganic salts on the electrode plates. In FIG. 10, reactor chamber 10 is illustrated within which electrolytic cell 12 is preferably disposed. At least one, and preferably a pair of ultrasonic probes 14 are preferably disposed such that they are in contact with the wastewater, but are preferably not directly attached to the plates of the cell. Ultrasound is preferably used to keep electrolytic cell 12 from precipitating and corroding the plates. Ultrasound is also used to produce the small seed crystals—most preferably with proper doping of the fluid.

The electrolytic cell 12 is preferably configured as a bolted arrangement of anode plates, 16, which can include monopolar anode plates, and cathode plates 18, which can include monopolar cathode plates. The term “electrode plates” can include one or more of anode plates 16, one or more of cathode plates 18, one or more bipolar plates 20, or any combination thereof. Optionally, electrolytic cell 12 can also include one or more bipolar plates 20. Although the figures illustrate bipolar plates 20, they are not essential and can optionally not be provided. In one embodiment, as best illustrated in FIG. 5, in one embodiment, electrode rods 22 which can be used to provide structural mounting and/or electrical current connection to one or more anode plates 16, one or more cathode plates 18 and, if provided one or more bipolar plates 20. In one embodiment, one or both of rods 22 can comprise a bolt or piece of all-thread. Electrode rods 22 and/or insulating spacers 24 preferably connect through each monopolar anode, cathode, and/or bipolar plate at or near the center of the longest linear dimension of the plate, such as the center of a line drawn from one edge of the plate to the opposite edge of the plate. Optionally, electrode rods 22 can be non-threaded one or more electrode plates can optionally be welded thereto.

As best illustrated in FIG. 5, insulating spacers preferably insulate a plate from electrical contact with electrode rod 22. Optionally, a conductive contact 25 can comprise one or more individual components (for example a pair of washers pressed against the plate by a pair of opposing nuts that are threaded onto threaded electrode rod 22 and used to make secure physical and electrical contact between the plate and the electrode rod 22), or the plate itself can be configured to make secure mechanical and/or electrical contact with electrode rod 22. For example, in one embodiment, the plate can comprise threads cut into an opening disposed therein—optionally, the plate can be made thicker at the place where electrical contact is desired and a hole with threads can be disposed through this thicker portion. In one embodiment, electrode plates can be generally rectangular, but can optionally be configured to any other desired shape, including but not limited to round, square, or other shapes—most preferably including shapes that have a geometric center. The electrode plates can be formed to increase their total surface area by perforating them, stamping indentions in them, or mechanically forming grooves or other shapes, patterns or structures on or in the surface thereof. This additional surface area preferably enhances the precipitation of inorganic solids beyond a plate that does not have the additional surface area.

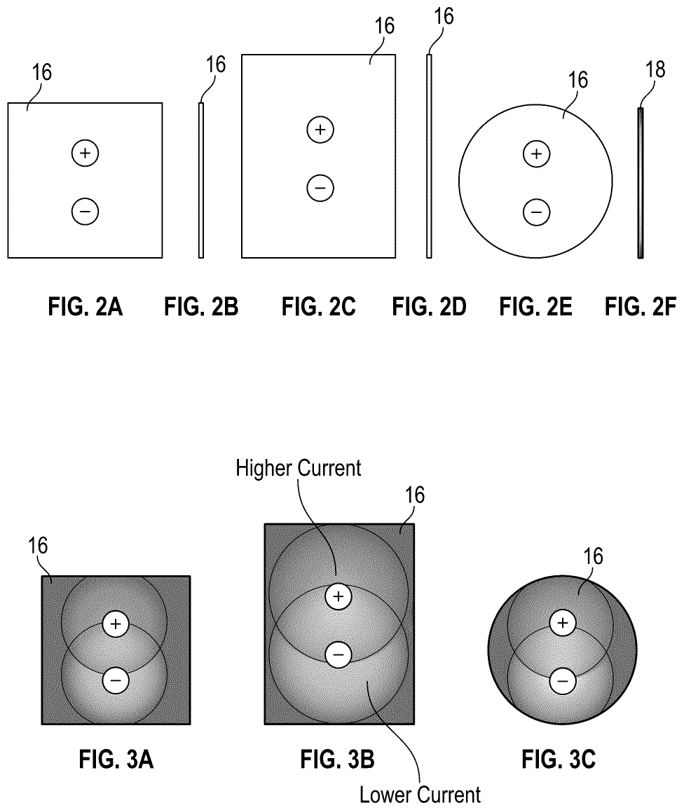

As best illustrated in FIGS. 2A-2F, square, rectangular, and circular electrode plates can be provided and are preferably provided with two holes disposed or otherwise formed at or near the geometric center of each plate. In this embodiment, each plate has two holes for providing for the electrode rods, which can include anode and/or cathode, to be bolted thereto, or to otherwise be spaced apart from with insulating spacers 24, which are most preferably formed from an electrically insulative material. The bolted configuration preferably supplies the current to each electrode plate and supports electrolytic cell 12 during high fluid flow rates in reactor 10.

Referring now to FIGS. 3A-3C, exemplary current distribution through each of a square electrode plate, a rectangular electrode plate, and a round electrode plate is preferably illustrated. This arrangement enables an even distribution of the current through monopolar plates to preferably minimize hot spots, corrosion, and scale build-up. Current concentration will typically be higher near the current pass-through bolt or weld.

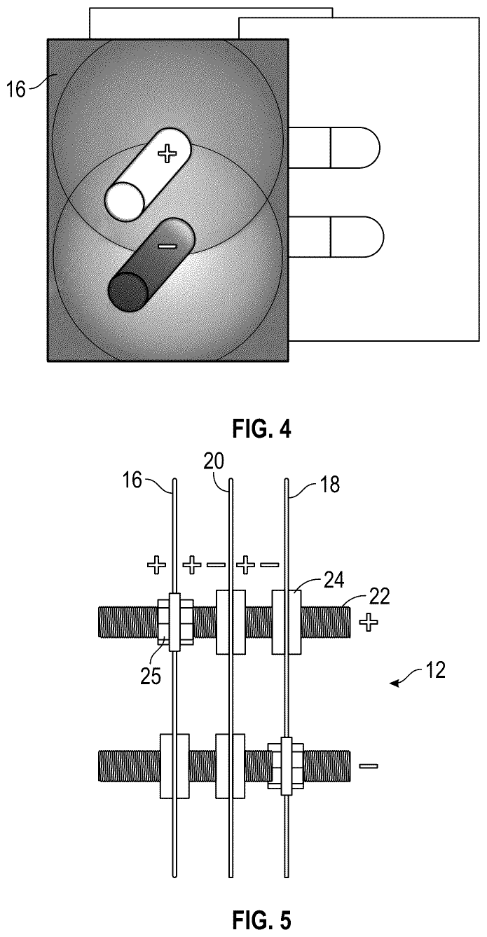

FIG. 4 and FIG. 5, which respectively illustrate a front view and a side view of electrolytic cell 12 containing a bipolar plate, and which show a bipolar plate 20 disposed between anode plate 16 and cathode plate 18 in a slot that is insulated from the monopole—most preferably with insulating spacers 24 that are formed from polyethylene or fiber glass. In this embodiment, bipolar plate 20 enables more uniform current distribution through the fluid medium. This arrangement prevents or otherwise inhibits the formation of hot spots, corrosion, and/or scale build-up. It has been generally found that for every insulated bipolar plate 20 that is inserted between monopolar plates 16 and 18, it increases voltage between 3 and 7 volts in brine over 5,000 total dissolved solids (“TDS”). For example, 10 bipolar plates 20 can increase voltage by up to about 70 volts. Bipolar plates can be used in water or brine—most preferably when the water or brine has a total dissolved solid concentration greater than about 3000 parts per million (“ppm”). Each bipolar plate can have at least a voltage drop of about 1.5 to about 3.5 volts per side to disassociate the water or salt molecule to create the mixed oxidant. The total voltage drop would be about 3 to about 7 volts.

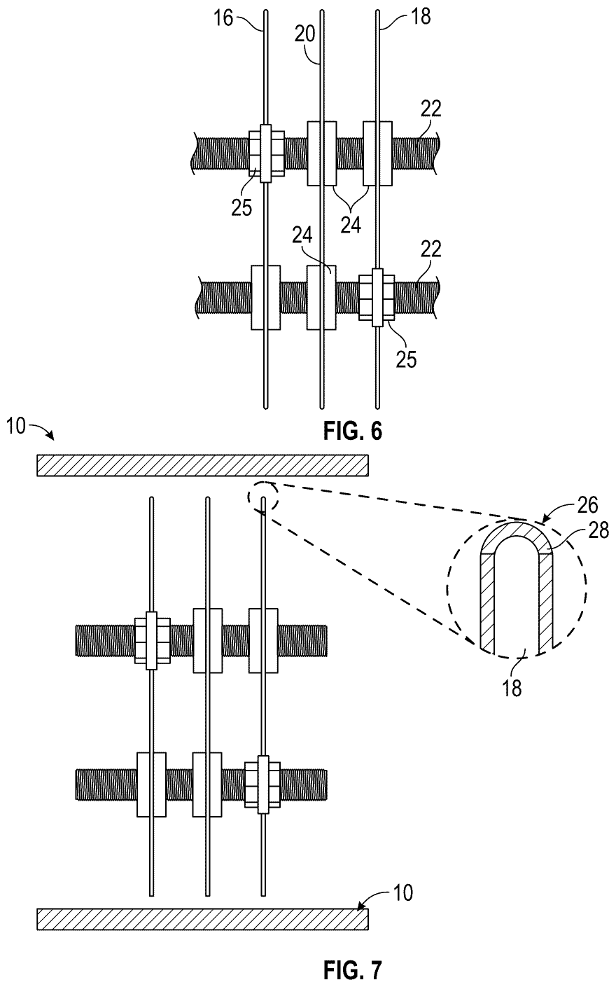

In one embodiment, electrolytic cell 12 can contain from a minimum of 3 to about 21 (or more) monopolar anode, cathode, and bipolar plates separated by insulating spacers as illustrated in FIG. 6. A conducting washer and nut, or other electrically conductive fasteners, structures, or welds are preferably used to spread current from across the electrode surface. Anode plate 16, cathode plate 18, and bipolar plate 20 are preferably cut and polished in such a manner as to further inhibit scale build-up that initiates corrosion of the electrode plates. FIG. 7 illustrates radiused edges 26 which are preferably formed onto the outer periphery edges of one or more electrode plates. FIG. 7 also illustrates the close spacing of the electrode plates to the wall of reactor chamber 10, which wall is most preferably formed from a non-conducting material. In one embodiment, non-conducting reactor wall is preferably about 0 to about 10 millimeters from the edge of electrode plates and more preferably about 0 to about 2 millimeters from the edge of the electrode plates. The electrode plates can optionally be coated with coating 28, which can optionally include a metallic and/or ceramic material. Most preferably coating 28 is formed using electro-chemical deposition of an alloy of iridium oxide, titanium oxide, vanadium oxide, or are ceramic coated using chemical vapor deposition (“CVD”) of boron or nitrogen doped diamond. The curved edges and coating preferably help inhibit the formation of corrosion—particularly for traditionally stamped plates.

In one embodiment, a spacing of about 0.25 centimeters (“cm”) to about 1.5 cm is provided between the electrode plates and can be determined by the desired plate voltage. The voltage can be determined by the sum of resistance of the plate material and fluid, then the sum multiplied by the amperage to treat the wastewater while allowing for larger particles to pass through without impeding the electrolytic reaction. Closer spacing can be used for fresh (non-saline) water with total dissolved solids of less than about 3000 ppm to reduce the voltage drop through the fresh water.

The outermost anode and cathode plates are preferably placed as close to the inter surface of walls of reactor chamber 10 as reasonably possible to treat the maximum volume of wastewater at high flow and for at least substantially 100%, or at least about 100% of the water to flow between electrode plates, without bypassing them. This can include, for example, configuring the cell such that the exterior surface of each of those outermost plates contacts the respective inner wall surfaces of reactor chamber 10—for example, electrolytic cell 12 can comprise dimensions that provide an interference fit within reactor chamber 10.

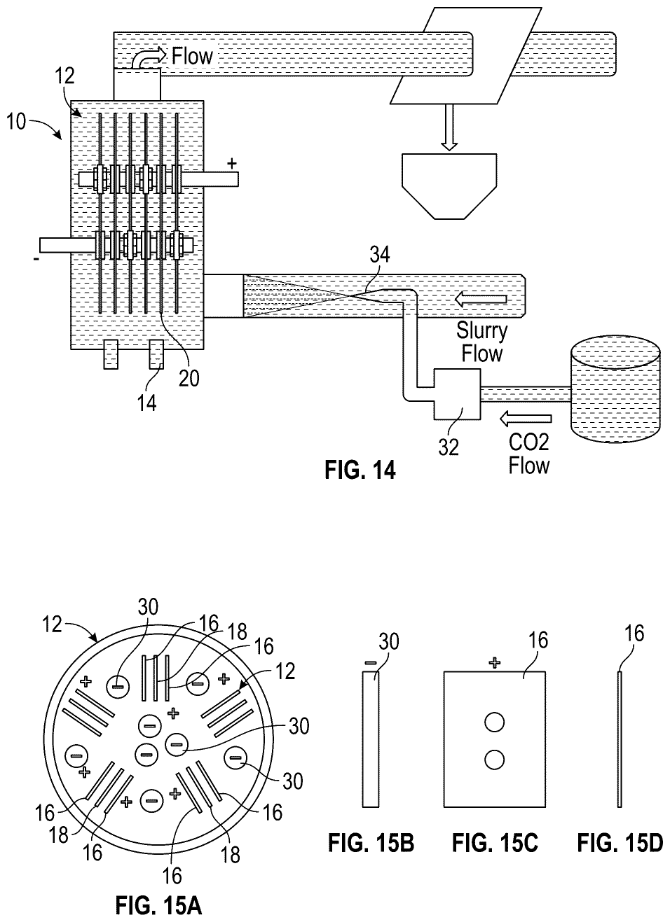

For specific monopolar operation with ultrasonic cleaning, a different configuration as illustrated in FIG. 15 is preferably provided using anode plates 16 to increase the surface area for oxidation and metallic return bars 30, acting as cathodes that are ultrasonically stimulated to continuously remove sticky or hard scale. Anode plates 16 can be perforated to increase surface area. FIG. 15 illustrates the configuration of the plates and bars with full ultrasonic bar immersion. This embodiment is configured to provide particularly desirable results for wastewater with high loads of precipitants. Carbon dioxide (“CO2”) or sulfur dioxide (“SO2”) are preferably injected into the water to form super-saturated water phase to enhance the precipitation of the target metals on the electrode surface or in bulk solution between the electrodes as illustrated in FIG. 13. Pump 32 and/or one or more venturi nozzles 34 (see FIG. 14), enable injection of a fluid pre-cursor material, which can comprise a gas, a liquid, and/or a mixture thereof, for enhanced treatment of the contaminated water.

Electrolytic cell 12, in any configuration, can optionally be coated such that the anodes and cathodes are coated separately—most preferably in their entirety so they each function as one single anode and cathode unit resonant piece, like a tuning fork, for the ultrasonic system to loosen the scale built-up over time. Both anode and cathode units are preferably bolted together for final assembly after coating. Coatings can be made of iridium oxide, ruthenium oxide, hafnium oxide, graphene oxide, or made of ceramic alloys including but not limited to boron-doped or nitrogen-doped diamond. If scale builds-up, corrosion of the cell will ensue and ruin the anode, cathode, and/or bipolar plates. In one embodiment where the coated electrodes are welded onto an electrically conductive back plane, electro-chemical deposition can be used for the final dip of ceramic coating over the back plane to create the corrosion resistant resonant piece.

In one embodiment, reactor chamber 10 preferably contains electrolytic cell 12 and immersible ultrasonic transducers 14 can be disposed in or otherwise coupled thereto. Most preferably, ultrasonic transducers 14 are preferably located upstream from electrolytic cell 12 as illustrated in FIGS. 10A and 10B. The offset between transducers 14 and electrodes 16, 18, and if provided 20, of electrolytic cell 12 is preferably between about 2.5 cm to about 10 cm to enable the sound to create a plane wave from the combination of two or more radial waves. The combination of multiple ultrasonic transducers preferably creates a uniform plane wave in a channel using the Fresnel mixing zone technique. The Fresnel mixing zone exists between about 1x and about 2x the transducer thickness. For instance, if transducer 14 has a 3 cm diameter rod, then the rods should be placed at about 6 cm distance from the plates and other rods for the Fresnel mixing zone to produce a near complete plane wave. A flat ultrasonic transducer 14 can be used for large reactor sizes as illustrated in FIG. 11C and the flat surface creates a plane wave to clean the electrode plates. Three different configurations to place ultrasonic transducers 14 in reactor chamber 10 are illustrated FIGS. 11A, 11B, and 11C. The first configuration has two ultrasonic transducers 14, which preferably have an elongated probe-type shape, at the bottom of the chamber. The second configuration includes the two probe-type ultrasonic transducers 14 at the bottom of the chamber with an additional transducer 14 having a probe-shape placed at the top of the chamber. The third configuration has ultrasonic transducer 14 with a probe-shape at the top of the chamber and ultrasonic transducer 14 having a flat plate-like shape disposed bottom of the chamber. These three configurations are merely exemplary configurations—other configurations can be used and will provide desirable results.

In one embodiment, transducers 14 emit between about 0.1 to about 1 watt of ultrasonic energy per square centimeter. A power level of about 0.1 watt per square centimeter is preferably used for seed crystal generation in the bulk fluid, and about 1.0 watt per square centimeter is preferably used for ultrasonic cleaning of the surface of the monopolar and bipolar plates, and for generation of small crystal particles for deposition on cathode or anode surfaces. The small crystals enhance the precipitation of inorganic salts on the electrode plate surfaces.

Generation of small (nano to micro-sized) crystals from ultrasound are preferably used to precipitate supersaturated fluids between the plates without precipitation on the surfaces of the electrode plates.

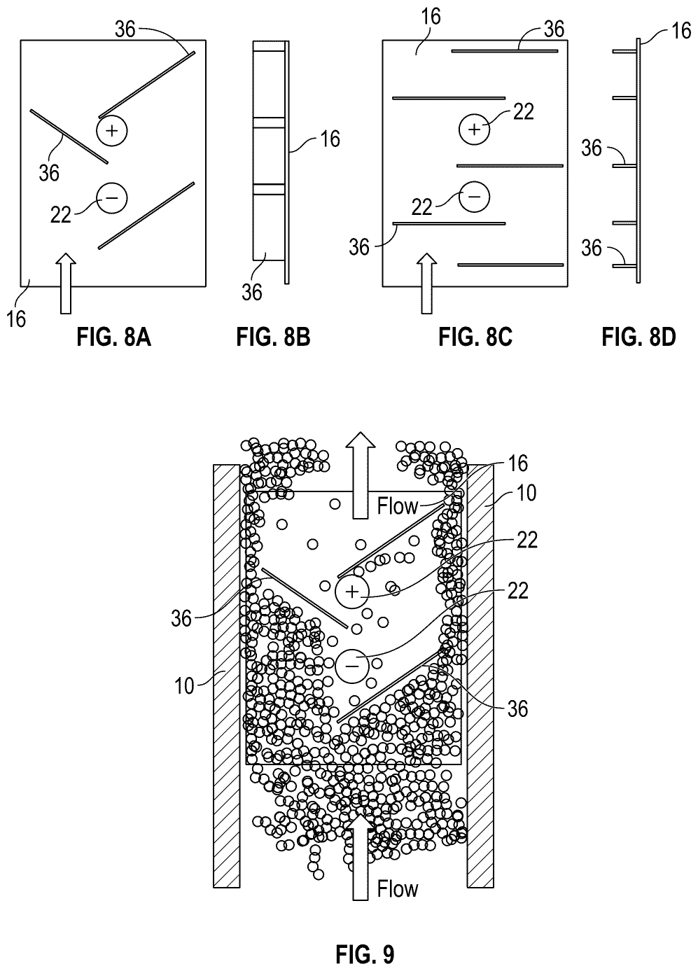

As best illustrated in FIGS. 8A-8D and FIG. 9, in one embodiment, cell spacers 36 are preferably provided on one or more of electrode plates 16, 18, and/or 20. Optionally, cell spacers 36 can be positioned at a slanted angle with respect to a flow of water such that cell spacers 36 act as baffles to guide bubbles and solids to the walls of the reactor as illustrated in FIG. 9 and/or to enhance uniform current distribution at or near the geometric center of the electrode plate and/or to reduce voltage across gaps. FIG. 9 illustrates a flow of bubbles across the electrode surface as water is pumped across the electrode surface. As can be seen in the figure, bubbles are pushed to the sides, thus creating maximum contact between the fluid and the plate surfaces. In this figure, the flow direction of the fluid is from bottom to top. Because bubbles impede the conductivity of the fluids and reduce the effectiveness of the electro-chemical process, it is desirable to force them to the sides to expose the electrode plate to the fluid. In one embodiment, cell spacers comprise elongated, at least substantially flat or curved strap-like shape and can be sized and shaped as illustrated in FIGS. 8A-8D. Optionally, however, spacers 36 can comprise a curved shape or other shape instead of a straight shape.

As illustrated in FIGS. 10A and 10B, ultrasonic transducers 14 are preferably not directly attached to the electrode plates nor to electrode rods 22 in electrolytic cell 12. Instead, wastewater is the medium that propagates sound and initiates vibration of electrolytic cell 12. Electrolytic cell 12 preferably resonates like a tuning fork without being directly attached to ultrasound transducers 14. The ultrasonic system is preferably tuned to vibrate the cell electrode pack at resonant frequency. Alternatively, the ultrasound can be modulated over a frequency range of about 1 kilohertz (“kHz”) to about 3 kHz to match each individual electrode plate's resonant frequency and to eliminate ultrasonic vibration dead spots. In one embodiment, frequencies used preferably range from about 16 kHz to about 50 kHz for modes 1-1, 0-1 and 1-0 plane wave resonant frequency of the electrode plates.

The flow of wastewater preferably enters reactor chamber 10 on the bottom and exits at the top, so that gravity segregation preferably separates the bubbles forming as part of the electrolytic reaction. The bubbles are swept downstream from electrolytic cell 12 out of the way of the propagating sound to vibrate the electrolytic plates (16, 18, and if provided 20) in electrolytic cell 12 at resonant frequency as illustrated in FIGS. 10A and 10B. Cell spacers 36 can be used to enhance the bubble segregation to the chamber walls as illustrated in FIG. 9.

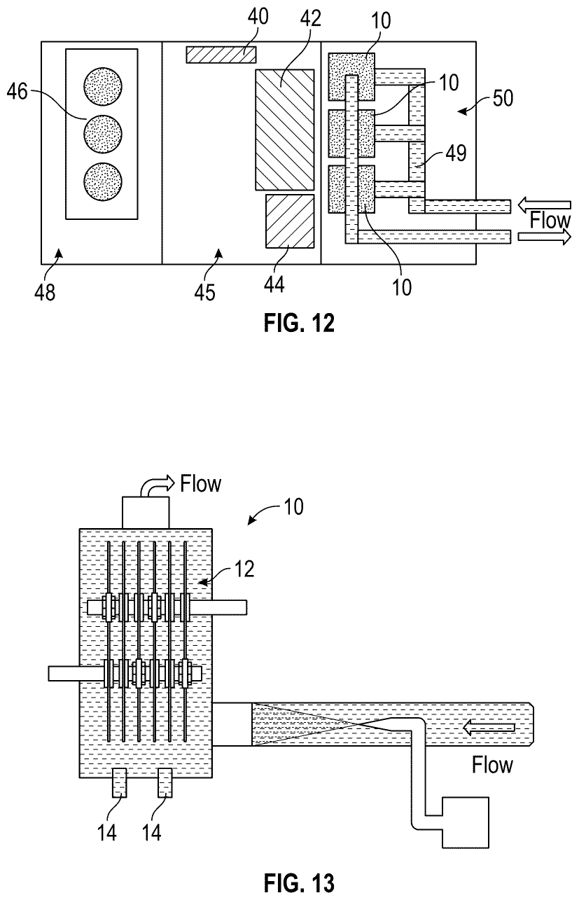

As illustrated in the top view of FIG. 12, in one embodiment, power 40, computing 42, and ultrasonic equipment 44 that is used to control amperage and sound preferably reside in dry area 45 to isolate them from any acid-caused corrosion, wetness, or other processes that negatively affect the power equipment. Water chiller 46 can optionally be disposed in hot area 48, while one or more reactor chambers 10 and associated plumbing 49 are preferably disposed in wet area 50. The entire apparatus can be installed in-situ, preferably inside a stationary building or mobile container or trailer—including for example a shipping container, to move the apparatus from project to project.

The flow volumes deemed “high-flow,” or “high-rate” applications preferably average about 15.2 cubic centimeter of raw water treated per square centimeter per minute of electrode area or more. The range of treated water is preferably about 1.52 cubic centimeter for highly loaded slurry to about 152 cubic centimeter per minute, or more, for clear brines per square centimeter of electrode area. The current to drive the electrode plates preferably range from about 10 milliamps (“mA”) per square centimeter to about 500 (“mA”) per square centimeter. The range is chosen such that an optimal pH is achieved on the boundary layer of the electrodes to precipitate the desired inorganic salt for the stage. For example, magnesium hydroxide precipitates at a pH of about 10.5, which is its lowest solubility point for the solid. Thus, the amperage on the cathode is preferably changed to achieve a pH of about 10.5 on the boundary layer by measuring the pH in real time until the desired pH is achieved. Keep in mind that the water or brine quality changes as it is treated, therefore the amperage varies with time to achieve the desired pH.

In one embodiment, for currents between about 10 to about 20 mA, a pH change can be produced from the bulk fluid pH of a positive about 1 to about 1.5 on the cathode plate and a negative pH change of about 1 to 1.5 on the anode plate. For currents between about 80 mA to about 500 mA, a pH of about 13 is produced on the cathode plate and a pH of approximately 1 on the anode plate. At this high current, the electrolytic reaction produces excessive amounts of bubbles on the cathode (hydrogen) and anode (oxygen and chlorine). The excess gases can be vented to the atmosphere to prevent a potential explosion.

In one embodiment, the present invention relates to an electro-chemical reaction cell comprising at least one pair of anode and cathode electrodes with upstream ultrasonic transducers with frequency range from 8 kHz to 45 kHz range for fluid treatment to generate nano-sized seed crystals and to clean inorganic precipitation from the electrode surface area. Optionally, ultrasonic transducers run with a square/rectangular pulse profile, at a power of about 0.01 to about 0.1 watts per cubic centimeter per minute of fluid for nano crystal generation and about 1 watt to about 40 watts per cubic centimeter per minute of fluid for electrode cleaning with nano crystal pulse with ranging from about 1 minute to about 40 minutes and the electrode cleaning pulse ranging from about 30 seconds to about 2 minutes. During the high amplitude pulse the ultrasonic frequency scanning range is from about 1 kilohertz (“kHz”) to 4 kHz. Current shape from anode to cathode electrode is preferably a square and/or rectangular pulse wave form that for low amperage amplitude ranges from about 0.01 to about 0.05 amps per square centimeter and for the high amperage amplitude ranges from about 0.1 to about 0.3 amps per square centimeter with low amperage pulse width ranging from about 10 to about 500 milliseconds (“msec”) and high amperage pulse width ranging from about 1 to about 10 msec to optimize deposition of inorganic matter on the electrode surface. Inorganic matter precipitated in bulk fluid or on the electrode surface is preferably collected with a downstream filtration unit sized to collect particles from about 1 micron to about 30 microns.

Embodiments of the present invention also relate to an electro-chemical reaction cell containing at least one pair of anode and cathode electrodes with upstream and downstream ultrasonic transducers with frequency range from about 8 kHz to about 45 kHz range for fluid treatment to generate nano-sized seed crystals and to clean inorganic precipitation from the electrode surface area. Ultrasonic transducers preferably run with a square and/or rectangular pulse profile with a power of about 0.01 to about 0.1 watts per cubic centimeter per minute of fluid for nano crystal generation and about 1 to about 40 watts per cubic centimeter per minute of fluid for electrode cleaning with nano crystal pulse with ranging from about 1 minute to about 40 minutes and the electrode cleaning pulse with ranging from about 30 seconds to about 2 minutes. During the high amplitude pulse the ultrasonic frequency scanning range is from about 1 kHz to about 4 kHz. Current shape from anode to cathode electrode is preferably a square/rectangular pulse wave form that for low amperage amplitude ranges from about 0.01 to about 0.05 amps per square centimeter and for the high amperage amplitude ranges from about 0.1 to about 0.3 amps per square centimeter with low amperage pulse width ranging from about 10 msec to about 500 msec and high amperage pulse width ranging from about 1 to about 10 msec to optimize deposition of inorganic matter on the electrode surface. Inorganic matter precipitated in bulk fluid or on the electrode surface is collect with downstream filtration unit sized to collect particles from about 1 micron to about 30 micron. Downstream ultrasonic transducers are used to remove polymerized or gummy organic or sulfur compounds from the electrode surface caused by oxidation.

Optionally, the anode coating can be a ceramic oxide alloy of iridium, ruthenium, vanadium or platinum oxides or boron/nitrogen doped diamond coating. For monopole operation of the electro-chemical reaction cell, the cathode material can optionally be solid stainless steel, nickel alloy or titanium alloy metal and the anode plate can be a solid or perforated coated surface.

In one embodiment, two or more electro-chemical reaction cells are preferably connected in series with different pulse width profiles for the one or more ultrasonic transducers to generate specific nano crystals from inorganic salts and different pulse width profiles for the anode/cathode electrode to precipitate specific inorganic salts onto electrode surface. Each reaction cell can have a downstream filtration unit to capture the specific precipitated inorganic salt.

The electro-chemical reaction cell can optionally be used with a precursor, including for example gaseous carbon dioxide, sulfur dioxide, sulfur trioxide or about 1 to about 6 molar liquid solution of sodium or potassium hydroxide, bicarbonate, sulfate, or carbonate salts. Concentration of precursor ion is preferably determined from about 100% to about 120% of stochiometric precipitation of the target inorganic ion in the water. Final treated water potential hydrogen (“pH”) is also adjusted using a base precursor such as sodium or potassium hydroxide or an acidic precursor such as hydrochloric or sulfuric acid. Gaseous precursor pressure is preferably set for each electro-chemical reaction cell to promote a specific range inorganic compound precipitation for downstream capture.

The electro-chemical reaction cell can be used to treat mixed organic and inorganic loaded wastewater by oxidizing organic molecules into bicarbonate or carbonate ion and using the generated bicarbonate or carbonate ion as a precursor addition in the next electro-chemical reaction cell to precipitate inorganic bicarbonate or carbonate salt compounds on electrode surface. Fluid pressure in both cells can optionally range from about 10 pounds per square inch (“psi”) to about 150 psi to promote bicarbonate or carbonate ion generation from dissolved carbon dioxide generated by organic matter oxidation. Resident time for each reactor preferably ranges from about 1 second to about 10 minutes, depending on the oxidation reaction rate in the first electro-chemical reaction cell and the precipitation reaction rate in the second electro-chemical reaction cell.

Ultrasonic transducers with frequency range from about 8 kHz to about 45 kHz can be used downstream to enhance the slow reaction rates of specific inorganic precipitation reactions in bulk fluid leaving the electro-chemical reaction cell. The ultrasonic cavitation in the bulk fluid enhances most inorganic reaction rates by changing from diffusion limited reaction to a mass limited reaction. The ultrasonic frequency scanning range is preferably from about 1 to about 4 kHz depending on the electro-chemical reaction cell size. Residence time preferably ranges from about 20 msec to about 1 minute depending on the chemical reaction rate.

In one embodiment, using the electro-chemical reaction cell, along with a vacuum distillation unit, brine is preferably concentrated to the sodium chloride saturation point while precipitating less soluble salts on the electrode surface. Ultrasound can be used to seed the brine with nano-sized seed crystals to prevent supersaturation in the brine during the vacuum distillation step.

In one embodiment, when electro-chemical reaction cell, saturated brine is preferably pressurized with carbon dioxide gas to at least about 600 psi to precipitate lithium carbonate on the cathode surface of the electro-chemical cell. The cell is operated in monopolar mode to recover lithium carbonate on the cathode surface. Replaceable cathode plates are preferably used to recover the lithium carbonate precipitation for subsequent refining to lithium metal.

Note that in the specification and claims, “about” or “approximately” means within twenty percent (20%) of the amount or value given.

Embodiments of the present invention can include every combination of features that are shown herein independently from each other. Although the invention has been described in detail with reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguring their relationships with one another.

### INDUSTRIAL APPLICABILITY

The invention is further illustrated by the following non-limiting examples.

### Example 1—Sour Water Treatment from Water Flooding Operations in New Mexico

“Sour water” is a produced brine from oil production or is also present in municipal sewage fermenters among many different wastewaters, with near-saturated H₂S with or without CO2. The goal of one embodiment of treatment is to produce a clear sweet brine without organic or hardness contamination. The sour water can be treated through a cell as illustrated in FIG. 11 to oxidize the hydrogen sulfide (“H₂S”) ion to manufacture elemental sulfur, hydrogen sulfate (“H2SO4”), and/or hydrogen sulfite (“H2SO3”). Elemental sulfur is insoluble in water, but the sulfate and sulfite ions are water soluble, and decrease the pH in the treated water or brine.

For produced oil field sour brines, there's also elemental iron and iron sulfide (“FeS2”) dissolved in the brine or present as a suspended particle. Most suspended iron sulfide particles are pyrophoric and represent a safety hazard. The oxidation requirement for elemental iron and iron sulfide usually exceeds the oxidation requirements of dissolved hydrogen sulfide (“H₂S”) gas.

Both elemental iron and iron sulfide end up as furoic iron (“Fe2O3”) and can precipitate as an iron oxide or iron oxide calcium carbonate. Iron sulfide particles are usually oxidized to soluble iron sulfate ion. This lowers the pH of the brine that requires neutralization back to a pH of about 6.5. Sodium carbonate or sodium hydroxide are good neutralization agents to generate a clear brine. Lime can also be added as a neutralizer to the acidic treated brine and will cause precipitation of calcium iron carbonate salt. The typical current loading for sour water treatment is about 30 mA to about 60 mA per square centimeter of electrode surface at low electro-chemical cell pressure, which in one embodiment preferably does not exceed 40 pounds per square inch—gage (“psig”). This process results in sweet brine that can be reused for recirculating waterflooding or hydraulic fracturing operations in the oil fields among other applications.

### Example 2— High-Flow, High Volume Water Recycling in the Permian Basin

The goal of water recycling is to produce a sweet brine for hydraulic fracture operations from produced water stored in ponds over several months. Stored wastewater ponds can accumulate organic matter through algae, bacterial growth, and/or black mold on the bottom due to emulsified carry over oil acting as a food source. Blowing dust and influx of organic and inorganic materials in these ponds cause the bio-matter growth to accelerate.

The sources of organic matters in addition to the residual oil are chemical components used in hydraulic fracture treatments, like sheared friction reducers, corrosion inhibitors, and viscofiers.

The organics as well as the biocides in conjunction with sunlight become additional food for all manners of algae, bacteria, and molds. The pond treatment needs to precipitate the hardness and oxidize the organics to carbon dioxide to generate a clear, reusable brine. All organic matter is mineralized to carbonate ions and usually precipitates as calcium, magnesium, or iron carbonates.

In one embodiment, the brine pulled from the pond is preferably filtered down to about 20-microns to remove dust particles or other micro-solids. The pond is generally treated to about 350 oxidation-reduction potential (“ORP”) for about 2 to about 3 days storage to 900+ORP for beyond about 1 month storage.

Hydrogen peroxide, ozone, or bleach can be introduced as a precursor to the treatment at the beginning of pond treatment to accelerate the demulsification of oil and/or water mixtures and oxidize the biofilm in the pond to avoid sticking particles to the electrode surface and reducing conductivity. After significant demulsification or after breakover oxidation of the organic matter, the hydrogen peroxide, ozone, or bleach is no longer required, and the apparatus can operate and sustain the reaction without precursors.

Optionally, multiple reactors can be run in series to completely oxidize the organic or inorganic matter in the beginning phase of the pond treatment. After breakover oxidation, the reactors are preferably run in parallel to treat water at a higher rate to complete the pond water treatment.

To produce mixed oxidants running the reactors in series or parallel, each reactor chamber can be equipped with differently coated cells to produce a variety of oxidants. For example, ruthenium-rich coating yield the maximum amounts of hypochlorite, iridium-rich coating survives H2S and FeS2 contamination while producing hypochlorite and iron sulfite, and nitrogen/boron-doped diamond coating is optimized for ozone (“O3”) generation from water (“H2O”).

Sodium bromide introduced as a precursor to the treatment for long-term storage can be added to the brine to generate the hypo-bromate oxidant that resists sunlight exposure and maintains the sterile water for up to about 1 month. Otherwise, the pond is preferably retreated about every 2 to about 3 weeks to regenerate the chlorine, bromine, and peroxymonosulfate oxidants.

The addition of micro or nano-bubbles facilitate the flotation of sunken biomass from the bottom of the pond to its surface for skimming and degradation from the sunlight's UV. The nano-bubbles help maintain the dissolved oxygen content in the pond above about 15 ppm for at least 3 weeks. The high rate of flow through the cell above 100 cubic centimeters per minute per square centimeter of electrode surface produce the nano-sized bubbles from the electrolytic reaction.

To enhance the oxidation on the cathode side, additional oxygen can be added to the brine before entering the cell. This generates the hydroxyl ion (HO2) to form hydrogen peroxide (H2O2) in the bulk fluid of the pond.

Only a portion of the pond volume needs to be treated to raise the ORP reading to about 500+mV, but to ensure uniform treatment of the entire volume of the pond, recirculation of pond water using a pump or bubblers is preferably used. For large deep ponds, the treated water can segregate at the surface due to the temperature density difference of the cooler, deeper untreated brine in the pond.

A slip-stream configuration with some of the water flowing through the reactor chambers and some of the water bypassing the reactor chambers allows for approximately 10% to about 20% of the water to be treated with the mixed oxidants and recombined after treatment with the approximately 80% to about 90% of untreated water that bypassed the reactor chambers. This slip-stream configuration allows for extra high volumes of wastewater recycling treatment to levels of at least about 25,000 barrels per day per reactor chamber or more. A typical arrangement of about 3 to about 4 reactor chambers in a regular shipping container unit can treat at least about 100,000 barrels per day per container unit or more. The current loading of the cell preferably stays within about 20 to about 40 mA per square centimeter at a pressure of between about 1 to about 50 psig, depending on the friction pressure loss of pipe or hoses.

### Example 3— De-Emulsification of Flow Back Water from Completion Operations

Completion operations preferably include the first about 30 days of flow back wastewater from drilling, hydraulic fracturing, and other completion operations. This operation is preferably conducted at high pressures (for example, about 5000 psig). FIG. 15 illustrates a round chamber with solid bars for ultrasound. This cell configuration lends itself to be installed inside a high-pressure chamber (for example, about 5000 psig or more) like a wellhead assembly.

The wastewater can be emulsified with oil, clay particles, and surfactant residue from drilling or hydraulic fracturing. Tighter oil emulsions can be created when acid is used to stimulate the perforations prior to hydraulic fracturing. These emulsions are stable emulsions that do not naturally separate into oil phase and water phase when produced to the surface facilities.

The oil/water emulsion accumulates in separator or storage tanks and oil emulsions do not meet the basic sediment and water pipeline specifications and for transportation specifications. Furthermore, this oil/water emulsion is preferably treated at the waste oil facility. The goal is to break up the emulsion to separate the oil phase from the water phase. The entire flow back wastewater is pumped through the high-pressure reactor. Flow rate through the cell is adjusted so that enough oxidants are generated to oxidize the polymers and viscofiers to break the oil emulsion. The target ORP exiting the cell is preferably about 250 mV. This allows for phase separation in the produced oil separator. The current loading of the cell preferably stays within about 10 to about 30 mA per square centimeter to minimize off-gas production at a pressure of between about 30 to about 5000 psig, depending on the primary separator pressure.

### Example 4— Metal Precipitation and Cleaning of Mining Operations in Colorado

The wastewater from mining operations usually has some forms of metal sulfides or sulfates in the water. Left alone, the acid-producing bacteria and sulfate reducing bacteria in the wastewater generate copper, iron, magnesium, and nickel sulfates (transition metals) which lead to blue water that is toxic to life. The dust and organics added to this mix create an anaerobic environment that produces dangerous H2S for personnel working around the pond as well as creating a stink downwind of the pond.

The electro-chemical oxidation of H2S produces sulfuric acid which can be neutralized with the addition of sodium hydroxide or sodium carbonate as a post-cursor for release in the environment as a neutral pH water free of heavy metals. The wastewater is pumped, preferably at high pressure, through the reactor—carbon dioxide can be added as a precursor to enhance the precipitation of metals as carbonates. The carbonates are preferably filtered out downstream from the cell with a self-cleaning filter. Metal carbonates, including for example iron carbonate, calcium carbonate, manganese carbonate, and magnesium carbonate, among others, are produced through the reaction. Excess carbon dioxide can be removed from the wastewater with downstream ultrasonic treatment with about 0.1 to about 0.5 watts per cubic centimeter of treated fluid. The resulting treated water can be further treated with reverse osmosis (“RO”) to achieve less than about 300 ppm total dissolved solids (“TDS”) in the softened freshwater for leach mining operations. This eliminates precipitation when mixed with natural waters in the environment. The current loading of the cell should stay within about 10 to about 50 mA per square centimeter at a pressure of between about 30 to about 150 psig, depending on the metal or inorganic salt that is intended to precipitate.

### Example 5— Metal Capture from Red Mud in Aluminum Manufacturing

Red mud is often stored in exceptionally large ponds from aluminum smelter operations. These ponds are further mixed with rain and exposed to dust and other organic matters. Red mud mounds are also found with a dried version of the residue from aluminum smelters. The red mud contains up to about 35% iron oxide with other trace element metals depending on the source of the material. Trace amounts of metals can include Scandium, Lithium, Vanadium among other metals and rare earth elements. If present in sufficient quantities, it is profitable to capture the metals and rare earth elements.

The red mud is ground up to less than about ¼ inch size and is converted into a high or low pH slurry for treatment. In addition, the slurry is disaggregated with ultrasound to further reduce the particle size below about 5 microns in the slurry so that the electro-chemical reaction can physically leach the desired metal from the slurry.

For low pH leach brine from the red mud pond, the focus is to capture iron on the cathode. For high pH, the focus is to capture valuable trace elements on the cathode or the anode, depending on the natural state of the metal ion (positive or negative).

To treat the red mud pond, an approximately 10-14 pound per gallon (“lb./gal.”) slurry is made from red mud and water and pump through the reactor chamber to separate desired metal oxides. If TDS is <about 10,000 ppm, then add sodium chloride or sodium sulfate to increase the slurry conductivity. Proceed to pump the slurry through the reactor to separate one or more of the elements from the red mud. Typically, iron is leached first from the aluminum oxide because of its high concentration in the slurry. This leaves the trace elements minus the iron element in the slurry. Then, cascade the reactor chambers to pull the next useful metal based on controlling the pH in the electrolytic reaction. Each subsequent reactor has a higher current per square centimeter to precipitate the target metal. Carbon dioxide is preferably added at pressure below about 100 psig before any of the electro-chemical cells in the cascade to capture trace elements, and then above about 600 psig to capture Lithium which is the last element to precipitate with carbon dioxide.

The current loading of the cell preferably stays within about 10 to about 20 mA per square centimeter to separate iron and iron oxides, the next current loading in the cascade preferably stays within about 30 to about 60 mA per square centimeter to separate the individual trace elements with the proper carbon dioxide pressure. FIG. 14 illustrates the general process to reclaim metals. The diagram showing the overall process of metal capture from slurries originating in industrial wastes like red mud and coal combustible residuals

### Example 6— Ash Pond Water Reclaim from Coal-Fired Electric Generation

Ash pond water can be rich in combustion coal residual (“CCR”), which contains many metals from co-deposited volcanic ash in coal, specifically lignite coal ash ponds. Metals can be captured that have been leached due to acid rain and biological activity, including sulfate reduction to sulfite. The residual treated water after metal capture can be released to the environment after redundant RO or nano-filtration. The wastewater is preferably pumped into a closed pipe and CO2 is added at a pressure of about 300 psig to the wastewater to precipitate nearly all the metals, except Lithium which precipitates at above about 600 psig. The metal oxide carbonate salts are captured on the cathode or anode depending on the ion polarity. The ultrasonic treatment releases the hard metal oxide scale from the cathode or anode surfaces and an about sub-5-micron filter captures the precipitant. The current loading of the cell preferably stays within about 20 to about 40 mA per square centimeter at a pressure of between about 50 psig to about 300 psig. Lithium element is captured at about 600 psig in a subsequent cascade. FIG. 14 illustrates the general process to reclaim metals.

### Example 7— Lithium Recovery from Saltwater Disposal Well in the Oil Field

Produced brine from the oil fields in the Permian Basin contains between 19 to 54 ppm lithium ion in the 65,000 to 130,000 total dissolved solids brine. To increase the efficiency of lithium capture by precipitation of lithium carbonate, the brine must be concentrated to sodium chloride saturation of approximately 310,000 total dissolved solids.

First, the raw brine is treated by electro-chemical oxidation to remove all organic and sulfur compounds to prevent sticky deposits on the heat exchanger surface. The oxidation of organic and sulfur compounds releases carbonate and sulfate ions into the brine, which in turn react with calcium, iron, and magnesium to form precipitation on the electrode surface. Ultrasound is used to remove the precipitant and asphaltene deposits from the electrode surface. Filtration is used to capture the solid precipitant.

Next, the brine is concentrated by vacuum distillation while circulating through the second stage electro-chemical cell. Ultrasound is used to clean the electrode surface and create nano-sized seed crystals in the bulk brine. The anode coating is changed to generate oxygen gas instead of mixed oxidant to prevent corrosion of the heat exchanger surface. The brine is now concentrated to saturation point of sodium chloride with is about 310,000 total dissolved solids depending on the vacuum distillation temperature. The electro-chemical cell preferably maintains the brine saturation index lower than about −1.0 to prevent precipitation on the heat exchanger surface.

Next, the saturated brine is pressurized with carbon dioxide gas to about 600 psi and pumped through the third stage electro-chemical cell for lithium carbonate precipitation. The electro-chemical cell is operated in monopolar mode only to recover lithium carbonate on the high surface area cathode plates. Recovered cathode plates are drained and dried to insure lithium carbonate purity. Recovered freshwater from the vacuum distillation of the brine is recycled back to the oil industry or to the local agriculture market.

The preceding examples can be repeated with similar success by substituting the generically or specifically described components and/or operating conditions of embodiments of the present invention for those used in the preceding examples.

Optionally, embodiments of the present invention can include a general or specific purpose computer or distributed system programmed with computer software implementing steps described above, which computer software may be in any appropriate computer language, including but not limited to C, C++, FORTRAN, BASIC, Java, Python, Linux, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

The terms, “a”, “an”, “the”, and “said” mean “one or more” unless context explicitly dictates otherwise.

Note that in the specification and claims, “about”, “approximately”, and/or “substantially” means within twenty percent (20%) of the amount, value, or condition given. All computer software disclosed herein may be embodied on any non-transitory computer-readable medium (including combinations of mediums), including without limitation CD-ROMs, DVD-ROMs, hard drives (local or network storage device), USB keys, other removable drives, ROM, and firmware.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguring their relationships with one another.

What is claimed is:

1. An electro-chemical reaction cell comprising:
at least one anode electrode;
at least one cathode electrode;
at least one ultrasonic transducer; said at least one ultrasonic transducer disposed in a location not directly coupled to said at least one anode electrode and not directly coupled to said at least one cathode electrode; and
said at least one ultrasonic transducer disposed such that when fluid is disposed within or otherwise passes through said electro-chemical reaction cell, mechanical conduction of ultrasonic waves is provided to said at least one anode electrode and to said at least one cathode electrode via said fluid.

2. The electro-chemical reaction cell of claim 1 wherein said at least one ultrasonic transducer is disposed upstream of said at least one anode electrode and of said at least one cathode electrode.

3. The electro-chemical reaction cell of claim 1 wherein said at least one ultrasonic transducer comprises at least two ultrasonic transducers.

4. The electro-chemical reaction cell of claim 1 wherein said at least one anode electrode comprises at least one anode electrode plate and wherein said at least one cathode electrode comprises at least one cathode electrode plate.

5. The electro-chemical reaction cell of claim 4 wherein said at least one cathode plate is attached to a cathode electrode rod by sandwiching it between a pair of threaded nuts with or without intervening washers.

6. The electro-chemical reaction cell of claim 4 wherein said at least one anode plate is attached to an anode electrode rod by sandwiching it between a pair of threaded nuts with or without intervening washers.

7. The electro-chemical reaction cell of claim 4 wherein said at least one anode plate is electrically isolated from a cathode electrode rod which passes through said at least one anode plate.

8. The electro-chemical reaction cell of claim 4 wherein said at least one cathode plate is electrically isolated from a cathode electrode rod which passes through said at least one anode plate.

9. The electro-chemical reaction cell of claim 1 comprising at least one cell spacer disposed on at least one of said at least one cathode electrode and/or disposed on at least one of said at least one anode electrode.

10. The electro-chemical reaction cell of claim 1 wherein said at least one cell spacer comprises a plurality of cell spacers and wherein said plurality of cell spacers are positioned such that bubbles within the fluid are directed to the sides of said at least one cathode electrode and/or to the sides of said at least one anode electrode.

11. A method for providing an electro-chemical reaction comprising:
passing a flow of current from at least one anode electrode, through a fluid to be treated, to at least one cathode electrode; and
applying ultrasonic vibrations to at least one of the at least one anode electrode and/or the at least one cathode electrode by conducting the ultrasonic vibrations through the fluid to be treated, without directly coupling an ultrasonic transducer to the at least one anode electrode or the at least one cathode electrode.

12. The method of claim 11 further comprising passing the fluid by an ultrasonic transducer before the fluid passes the at least one anode electrode and before the fluid passes the at least one cathode electrode.

13. The method of claim 11 further comprising forming nano crystals in the ultrasonic vibrations conducted through the fluid.

14. The method of claim 11 further comprising at least partially cleaning at least one of the at least one anode electrode and/or the at least one cathode electrode with the applied ultrasonic vibrations.

15. The method of claim 11 wherein applying ultrasonic vibrations comprises applying ultrasonic vibrations which are tuned to a resonant frequency of at least one of the at least one anode electrode and or of the at least one cathode electrode.

16. The method of claim 11 wherein applying ultrasonic vibrations comprises applying ultrasonic vibrations which comprise a frequency of between about 8 kilohertz to about 45 kilohertz.

17. The method of claim 11 wherein applying ultrasonic vibrations comprises applying ultrasonic vibrations at a first power level for nano seed crystal generation and at a second power level for electrode cleaning.

18. The method of claim 17 wherein the first power level comprises a power level of about 0.01 watts per cubic centimeter per minute of fluid flow to a power level of about 0.1 watts per cubic centimeter per minute of fluid flow.

19. The method of claim 17 wherein the second power level comprises a power level of about 1 watt per cubic centimeter per minute of fluid flow to a power level of about 40 watts per cubic centimeter per minute of fluid flow.

20. The method of claim 11 further comprising directing bubbles away from at least one of the at least one anode electrode and/or the at least one cathode electrode with one or more cell spacers.
